(19) United States
(12) Patent Application Publication
(10) Pub. No.: US 2026/0325938 A1
(43) Pub. Date: Oct. 22, 2026

(54) METHOD AND SYSTEM FOR DETERMINING ALIGNMENT INFORMATION FOR GOLF SHOT ANALYSIS

(71) Applicant: CREATZ INC., Suwon-si Gyeonggi-do (KR)

(72) Inventors: Jey Ho SUK, Seoul (KR); Yong Ho SUK, Seongnam-si Gyeonggi-do (KR); Kyong Jong LEE, Suwon-si Gyeonggi-do (KR); Hyeon Seok CHOI, Seoul (KR)

(73) Assignee: CREATZ INC., Suwon-si Gyeonggi-do (KR)

(21) Appl. No.: 19/712,355

(22) Filed: Jun. 18, 2026

Related U.S. Application Data
(63) Continuation of application No. PCT/KR2024/019569, filed on Dec. 3, 2024.

(30) Foreign Application Priority Data
Dec. 19, 2023 (KR) 10-2023-0186463

(51) Int. Cl. A63B 69/36; G06T 7/70

(52) U.S. Cl. CPC A63B 69/3658; G06T 7/70; A63B 2220/807

(57) ABSTRACT

According to one aspect of the present invention, there is provided a method for determining alignment information for golf shot analysis, the method comprising the steps of: acquiring at least one of first information on a reference position and second information on a target position; and determining alignment information of a device for golf shot analysis with reference to at least one of the first information and the second information.

### CROSS-REFERENCE TO RELATED APPLICATIONS

This application is a continuation of International Application No. PCT/KR2024/019569 filed on Dec. 3, 2024, which claims priority to Korean Patent Application No. 10-2023-0186463 filed on Dec. 19, 2023, the entire contents of which are herein incorporated by reference.

### FIELD OF THE INVENTION

The present invention relates to a method and system for determining alignment information for golf shot analysis.

### BACKGROUND

In recent years, the domestic and international golf industries have been steadily growing as the number of people playing golf has been increasing with the increase in leisure time, and various techniques for golf shot analysis are being proposed.

FIG. 3 illustrates a method of analyzing a golf shot using a device according to the prior art.

Referring to FIG. 3, a conventional technique related to a method of analyzing a golf shot using a device (e.g., a golf launch monitor) has been proposed in which a user places the device on the ground and places a separate alignment stick in a target direction, so that the alignment stick is used to correct golf shot data.

However, according to the conventional technique, the user personally places the alignment stick on the ground and the device detects a direction in which the alignment stick is placed to correct the golf shot data, which may cause a problem that it is difficult to accurately analyze the golf shot due to errors occurring when the user fails to place the alignment stick in the correct direction.

In this connection, the inventor(s) present a technique for precisely analyzing a golf shot by acquiring at least one of first information on a reference position and second information on a target position, and determining alignment information of a device for golf shot analysis with reference to at least one of the first information and the second information.

### SUMMARY OF THE INVENTION

One object of the present invention is to solve all the above-described problems in the prior art.

Another object of the invention is to acquire at least one of first information on a reference position and second information on a target position, and determine alignment information of a device for golf shot analysis with reference to at least one of the first information and the second information.

Yet another object of the invention is to precisely determine alignment information for golf shot analysis by acquiring at least one of first information on a reference position and second information on a target position from an image sensor.

Still another object of the invention is to precisely analyze a golf shot by acquiring at least one image of the golf shot and applying alignment information to the image.

The representative configurations of the invention to achieve the above objects are described below.

According to one aspect of the invention, there is provided a method comprising the steps of: acquiring at least one of first information on a reference position and second information on a target position; and determining alignment information of a device for golf shot analysis with reference to at least one of the first information and the second information.

According to another aspect of the invention, there is provided a system comprising: an information acquisition unit configured to acquire at least one of first information on a reference position and second information on a target position; and an alignment information determination unit configured to determine alignment information of a device for golf shot analysis with reference to at least one of the first information and the second information.

In addition, there are further provided other methods and systems to implement the invention, as well as non-transitory computer-readable recording media having stored thereon computer programs for executing the methods.

According to the invention, it is possible to acquire at least one of first information on a reference position and second information on a target position, and determine alignment information of a device for golf shot analysis with reference to at least one of the first information and the second information.

According to the invention, it is possible to precisely determine alignment information for golf shot analysis by acquiring at least one of first information on a reference position and second information on a target position from an image sensor.

According to the invention, it is possible to precisely analyze a golf shot by acquiring at least one image of the golf shot and applying alignment information to the image.

### BRIEF DESCRIPTION OF THE DRAWINGS

FIG. 1 schematically shows the configuration of an entire system for determining alignment information for golf shot analysis according to one embodiment of the invention.

FIG. 2 specifically shows the internal configuration of a golf shot analysis system according to one embodiment of the invention.

FIG. 3 illustrates a method of analyzing a golf shot using a device according to the prior art.

FIG. 4 illustratively shows a situation in which alignment information of a device is determined according to one embodiment of the invention.

FIG. 5 illustratively shows a situation in which alignment information of a device is determined according to one embodiment of the invention.

### DETAILED DESCRIPTION OF THE INVENTION

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures, and characteristics described herein may be implemented as modified from one embodiment to another without departing from the spirit and scope of the invention. Furthermore, it shall be understood that the positions or arrangements of individual elements within each embodiment may also be modified without departing from the spirit and scope of the invention. Therefore, the following detailed description is not to be taken in a limiting sense, and the scope of the invention is to be taken as encompassing the scope of the appended claims and all equivalents thereof. In the drawings, like reference numerals refer to the same or similar elements throughout the several views.

Hereinafter, various preferred embodiments of the invention will be described in detail with reference to the accompanying drawings to enable those skilled in the art to easily implement the invention.

### Configuration of the Entire System

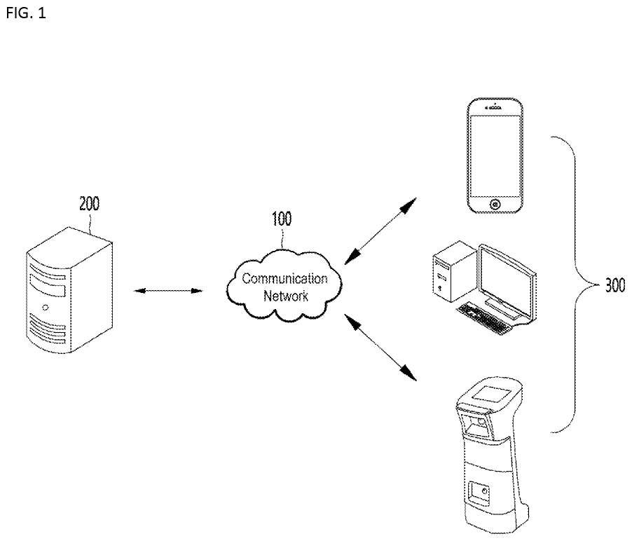

FIG. 1 schematically shows the configuration of the entire system for determining alignment information for golf shot analysis according to one embodiment of the invention.

As shown in FIG. 1, the entire system according to one embodiment of the invention may comprise a communication network 100, a golf shot analysis system 200, and a device 300.

First, the communication network 100 according to one embodiment of the invention may be implemented regardless of communication modality such as wired and wireless communications, and may be constructed from a variety of communication networks such as local area networks (LANs), metropolitan area networks (MANs), and wide area networks (WANs). Preferably, the communication network 100 described herein may be the Internet or the World Wide Web (WWW). However, the communication network 100 is not necessarily limited thereto, and may at least partially include known wired/wireless data communication networks, known telephone networks, or known wired/wireless television communication networks.

For example, the communication network 100 may be a wireless data communication network, at least a part of which may be implemented with a conventional communication scheme such as WiFi communication, WiFi-Direct communication, Long Term Evolution (LTE) communication, 5G communication, Bluetooth communication (including Bluetooth Low Energy (BLE) communication), infrared communication, and ultrasonic communication. As another example, the communication network 100 may be an optical communication network, at least a part of which may be implemented with a conventional communication scheme such as LiFi (Light Fidelity).

Next, the golf shot analysis system 200 according to one embodiment of the invention may function to acquire at least one of first information on a reference position and second information on a target position, and determine alignment information of a device for golf shot analysis with reference to at least one of the first information and the second information.

The configuration and functions of the golf shot analysis system 200 according to the invention will be discussed in more detail below.

Next, the device 300 according to one embodiment of the invention is digital equipment capable of connecting to and then communicating with the golf shot analysis system 200, and any type of digital equipment having a memory means and a microprocessor for computing capabilities, such as a smart phone, a tablet, a smart watch, a smart band, smart glasses, a desktop computer, a notebook computer, a workstation, a personal digital assistant (PDA), a web pad, and a mobile phone, may be adopted as the device 300 according to the invention.

In particular, the device 300 may include an application (not shown) for assisting the user to be provided with the functions according to the invention from the golf shot analysis system 200. The application may be downloaded from the golf shot analysis system 200 or an external application distribution server (not shown). Meanwhile, the characteristics of the application may be generally similar to those of an information acquisition unit 210, an alignment information determination unit 220, a communication unit 230, and a control unit 240 of the golf shot analysis system 200 to be described below. Here, at least a part of the application may be replaced with a hardware device or a firmware device that may perform a substantially equal or equivalent function, as necessary.

### Configuration of the Golf Shot Analysis System

Hereinafter, the internal configuration of the golf shot analysis system 200 crucial for implementing the invention and the functions of the respective components thereof will be discussed.

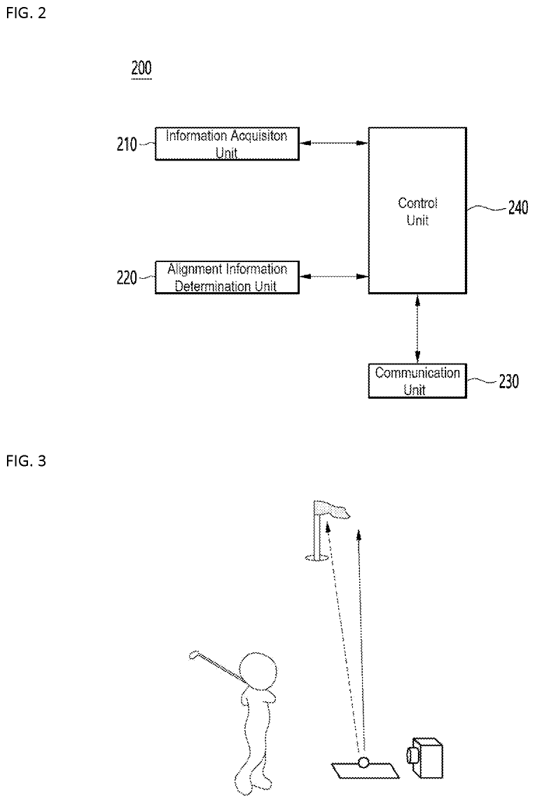

FIG. 2 specifically shows the internal configuration of the golf shot analysis system 200 according to one embodiment of the invention.

As shown in FIG. 2, the golf shot analysis system 200 according to one embodiment of the invention may comprise an information acquisition unit 210, an alignment information determination unit 220, a communication unit 230, and a control unit 240. According to one embodiment of the invention, at least some of the information acquisition unit 210, the alignment information determination unit 220, the communication unit 230, and the control unit 240 may be program modules to communicate with an external system (not shown). The program modules may be included in the golf shot analysis system 200 in the form of operating systems, application program modules, and other program modules, while they may be physically stored in a variety of commonly known storage devices. Further, the program modules may also be stored in a remote storage device that may communicate with the golf shot analysis system 200. Meanwhile, such program modules may include, but are not limited to, routines, subroutines, programs, objects, components, data structures, and the like for performing specific tasks or executing specific abstract data types as will be described below in accordance with the invention.

Meanwhile, the above description is illustrative although the golf shot analysis system 200 has been described as above, and it will be apparent to those skilled in the art that at least a part of the components or functions of the golf shot analysis system 200 may be implemented in the device 300 or a server (not shown) or included in an external system (not shown), as necessary.

First, the information acquisition unit 210 according to one embodiment of the invention may function to acquire at least one of first information on a reference position and second information on a target position.

Specifically, the first information according to one embodiment of the invention may include at least one of position information of a user (e.g., a golfer) and position information of a golf ball. Here, the position information of the user according to one embodiment of the invention may include, but is not limited to, at least one of information on a position of a teeing area where the user is positioned and information on positions of both feet of the user (e.g., information on a center position of both feet of the user). Further, the position information of the golf ball according to one embodiment of the invention may include position information of a golf ball that the user places on the ground for a golf swing. In addition, according to one embodiment of the invention, the reference position may be determined as the user's position or the golf ball's position according to the user's input or preset conditions.

Further, the first information according to one embodiment of the invention may include information on a distance between the reference position and the device. Specifically, according to one embodiment of the invention, the position information of the user may include information on a distance between the user's position and the device. In addition, the position information of the golf ball according to one embodiment of the invention may include information on a distance between the golf ball's position and the device.

Further, the second information according to one embodiment of the invention may include information on a target position (e.g., a position of a hole cup). Specifically, the target position according to one embodiment of the invention may refer to, but is not limited to, a virtual target position in a virtual golf simulator system (not shown) (e.g., a position of a hole cup in a screen golf system) or a position of a hole cup in an actual golf course. For example, the target position according to one embodiment of the invention may refer to a specific position in the virtual golf simulator system or the actual golf course that is inputted (or selected) by the user, rather than the position of the hole cup.

For example, the information acquisition unit 210 according to one embodiment of the invention may acquire at least one of the first information and the second information from at least one image sensor included in the device. Specifically, at least one of the first information and the second information according to one embodiment of the invention may be acquired by photographing images at a point of time after the user is positioned in a teeing area to prepare for a golf shot or after the golf ball is placed on the ground for a golf shot. Further, the image sensor according to one embodiment of the invention may include a video sensor for photographing a plurality of consecutive images.

As a specific example, the information acquisition unit 210 according to one embodiment of the invention may acquire at least one of the first information and the second information in response to the user being positioned in the teeing area or the golf ball being placed on the ground (e.g., for a golf shot). Therefore, according to the invention, at least one of the first information and the second information may be acquired before the user's golf shot is made, so that precise alignment information may be determined.

As another example, the device according to one embodiment of the invention is a device for golf shot analysis, which may refer to, but is not limited to, a golf launch monitor, and any device capable of acquiring at least one of the first information and the second information may be included in the device according to the invention. Further, the device according to one embodiment of the invention may include at least one sensor (e.g., image sensor or radar sensor).

As another example, the device according to one embodiment of the invention may include at least one radar sensor. Specifically, the radar sensor according to one embodiment of the invention may refer to a sensor for acquiring information on at least one of a position, velocity, and direction of an object using electromagnetic waves. As a specific example, the information acquisition unit 210 according to one embodiment of the invention may acquire at least one of the first information (e.g., the distance between the reference position and the device) and the second information (e.g., the distance between the golf ball's position and the device) from a radar sensor included in the device.

As another example, the information acquisition unit 210 according to one embodiment of the invention may estimate at least one of the reference position and the target position on the basis of two or more images respectively acquired from two or more image sensors included in the device, and acquire a result of the estimation as at least one of the first information and the second information.

As a specific example, the two or more image sensors according to one embodiment of the invention may be included (or provided) in the device as spaced apart from each other. Here, the information acquisition unit 210 according to one embodiment of the invention may estimate at least one of the reference position and the target position on the basis of a phase difference between two or more images respectively acquired from the two or more sensors. Further, the information acquisition unit 210 according to one embodiment of the invention may acquire a result of the estimation as at least one of the first information and the second information. Here, according to one embodiment of the invention, the process of estimating at least one of the reference position and the target position on the basis of the two or more images may be performed using a stereo vision method. In addition, the stereo vision method according to one embodiment of the invention may refer to a method of estimating information on a distance to an object (e.g., depth information) by calculating two or more images acquired from two or more sensors placed at different positions.

Therefore, according to the invention, at least one of the first information and the second information may be estimated from two or more images, rather than from the user's arbitrary input, so that precise golf shot analysis may be performed.

Meanwhile, the information acquisition unit 210 according to one embodiment of the invention may acquire at least one of the first information and the second information from at least one sensor that is not included in the device. That is, at least one sensor (i.e., image sensor or radar sensor) according to one embodiment of the invention does not necessarily have to be included in the device, but may be included in a system inside or outside the golf shot analysis system 200.

As another example, the information acquisition unit 210 according to one embodiment of the invention may acquire at least one of the first information and the second information from a virtual golf simulator system.

As a specific example, the information acquisition unit 210 according to one embodiment of the invention may acquire the second information (e.g., position information of a hole cup in a virtual golf simulator game) from the virtual golf simulator system. Further, the information acquisition unit 210 according to one embodiment of the invention may acquire the first information (e.g., position information of a user in the virtual golf simulator game) from the virtual golf simulator system.

As another example, the information acquisition unit 210 according to one embodiment of the invention may acquire at least one of the first information and the second information on the basis of the user's input.

As a specific example, according to one embodiment of the invention, the user may input information on a distance between the device and the target position (e.g., 95 m) to the device. Here, the information acquisition unit 210 according to one embodiment of the invention may acquire the second information on the basis of the user's input.

As another specific example, the information acquisition unit 210 according to one embodiment of the invention may acquire the first information from at least one sensor and acquire the second information on the basis of the user's input.

As another specific example, the user according to one embodiment of the invention may input information on a specific reference target distance (e.g., 300 m), among at least one reference target distance (e.g., 100 m, 200 m, 300 m, 400 m, and 500 m), to the device. Here, the information acquisition unit 210 according to one embodiment of the invention may acquire the inputted information on the specific reference target distance as the second information. That is, the information acquisition unit 210 according to one embodiment of the invention may acquire information on a specific reference target distance inputted from the user, among at least one reference target distance, as the second information.

Therefore, according to the invention, if the user knows in advance information on a distance between the device and the target position, the second information may be acquired on the basis of the user's input, and even if the user does not specifically know the information on the distance between the device and the target position, the second information may be acquired by inputting information on a reference target distance.

As another example, the information acquisition unit 210 according to one embodiment of the invention may further acquire at least one of information on a golf course and information on a current position of the user in the golf course from a virtual golf simulator system, and may determine a distance between the user's position and the target position with reference to the golf course and the user's current position in the golf course, and acquire the determined distance between the user's position and the target position as the second information.

As a specific example, according to one embodiment of the invention, it may be assumed that the user is preparing for a tee shot on a first hole of a specific golf course. Here, the information acquisition unit 210 according to one embodiment of the invention may acquire information on the golf course and information on the user's current position, and may determine a distance between the user's position and the target position with reference to the golf course and the user's current position in the golf course (e.g., a distance from a teeing ground of the first hole to a hole cup may be determined as 340 m), and acquire the determined distance (e.g., 340 m) as the second information. Here, the information acquisition unit 210 according to one embodiment of the invention may further acquire the first information from at least one image sensor, but may also acquire the first information from the virtual golf simulator system.

Next, the alignment information determination unit 220 according to one embodiment of the invention may function to determine alignment information of a device for golf shot analysis with reference to at least one of the first information and the second information.

Specifically, the alignment information of the device according to one embodiment of the invention may include information (e.g., calibration information for image conversion) that is applied to at least one image of a golf shot to analyze the golf shot. Further, the alignment information of the device according to one embodiment of the invention may include alignment information for correcting a difference between a direction from the user's position (or the golf ball's position) to the target position and a direction from the device to the target position (e.g., an angle difference between the two directions).

For example, the alignment information determination unit 220 according to one embodiment of the invention may determine the alignment information by calculating an angle between a first direction from the reference position to the target position and a second direction from the device to the target position.

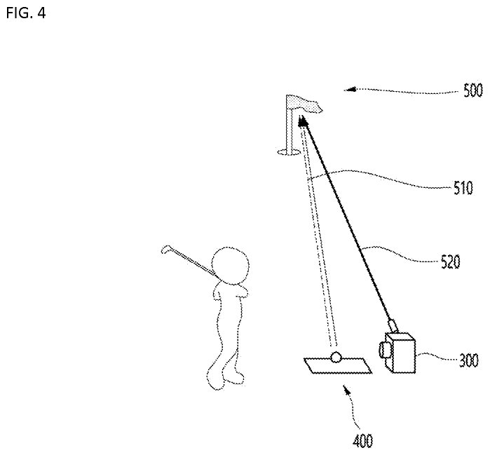

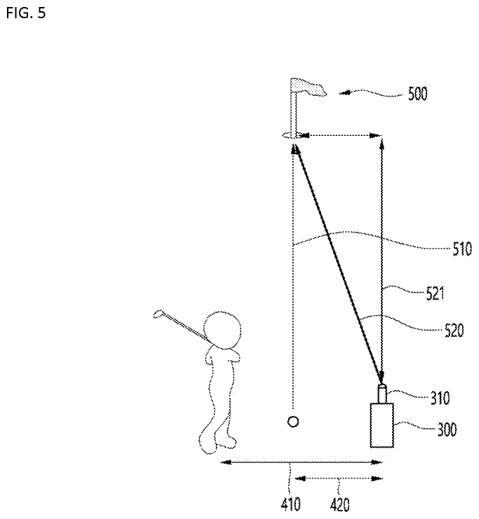

FIG. 4 illustratively shows a situation in which the alignment information of the device is determined according to one embodiment of the invention, and FIG. 5 illustratively shows a situation in which the alignment information of the device is determined according to one embodiment of the invention.

For example, referring to FIG. 4, the alignment information determination unit 220 according to one embodiment of the invention may determine the alignment information by calculating an angle between a first direction 510 from a reference position 400 to a target position 500 and a second direction 520 from the device 300 to the target position 500.

As another example, referring to FIG. 5, the alignment information determination unit 220 according to one embodiment of the invention may determine the alignment information by calculating an angle between the first direction 510 from the user's position to the target position 500 and the second direction 520 from the device 300 to the target position 500, in response to the reference position being determined as the user's position. Here, referring to FIG. 5, the alignment information determination unit 220 according to one embodiment of the invention may calculate the angle between the first direction 510 and the second direction 520 on the basis of a ratio of a distance 410 between the user's position and the device and a distance 521 between the device and the target position. For example, the alignment information determination unit 220 according to one embodiment of the invention may calculate the angle between the first direction 510 and the second direction 520 by applying an arctangent function to the distance 410 between the user's position and the device and the distance 521 between the device and the target position.

As another example, referring to FIG. 5, the alignment information determination unit 220 according to one embodiment of the invention may determine the alignment information by calculating an angle between the first direction 510 from the golf ball's position to the target position 500 and the second direction 520 from the device 300 to the target position 500, in response to the reference position being determined as the golf ball's position. Here, referring to FIG. 5, the alignment information determination unit 220 according to one embodiment of the invention may calculate the angle between the first direction 510 and the second direction 520 on the basis of a ratio of a distance 420 between the golf ball's position and the device and the distance 521 between the device and the target position. Further, according to one embodiment of the invention, the angle between the first direction 510 and the second direction 520 may be calculated by applying an arctangent function as described above.

Meanwhile, the manner of determining the alignment information according to the invention is not limited to the foregoing, but may be diversely changed as long as the objects of the invention may be achieved.

Meanwhile, the golf shot analysis system 200 according to one embodiment of the invention may further comprise a golf shot analysis unit (not shown).

The golf shot analysis unit according to one embodiment of the invention may function to acquire at least one image of a golf shot, and analyze the golf shot by applying the alignment information to the at least one image. Here, the analysis of the golf shot according to one embodiment of the invention may be performed by a component inside the device (e.g., a processor), but may also be performed by a component included in a system inside or outside the golf shot analysis system 200. Further, the at least one image of the golf shot according to one embodiment of the invention may be acquired from, but not limited to, at least one image sensor for photographing the user's golf shot.

For example, the golf shot analysis unit according to one embodiment of the invention may generate first analysis information by analyzing a golf shot by using at least one image of the golf shot. Then, the golf shot analysis unit according to one embodiment of the invention may generate second analysis information by analyzing the golf shot by applying the alignment information to the at least one image of the golf shot. Then, the golf shot analysis unit according to one embodiment of the invention may provide at least one of the first analysis information and the second analysis information via a display on the device. Here, at least one of the first analysis information and the second analysis information according to one embodiment of the invention may include, but is not limited to, a velocity, spin, and the like of the golf ball, and may include any physical quantity associated with the golf ball on the basis of which the golf shot may be analyzed.

Therefore, according to the invention, the user may compare the first analysis information to which the alignment information is not applied and the second analysis information to which the alignment information is applied, so that the golf shot may be specifically analyzed.

Next, the communication unit 230 according to one embodiment of the invention may function to enable data transmission/reception from/to the information acquisition unit 210 and the alignment information determination unit 220.

Lastly, the control unit 240 according to one embodiment of the invention may function to control data flow among the information acquisition unit 210, the alignment information determination unit 220, and the communication unit 230. That is, the control unit 240 according to one embodiment of the invention may control data flow into/out of the golf shot analysis system 200 or data flow among the respective components of the golf shot analysis system 200, such that the information acquisition unit 210, the alignment information determination unit 220, and the communication unit 230 may carry out their particular functions, respectively.

The embodiments according to the invention as described above may be implemented in the form of program instructions that can be executed by various computer components, and may be stored on a computer-readable recording medium. The computer-readable recording medium may include program instructions, data files, and data structures, separately or in combination. The program instructions stored on the computer-readable recording medium may be specially designed and configured for the present invention, or may also be known and available to those skilled in the computer software field. Examples of the computer-readable recording medium include the following: magnetic media such as hard disks, floppy disks, and magnetic tapes; optical media such as compact disk-read only memory (CD-ROM) and digital versatile disks (DVDs); magneto-optical media such as floptical disks; and hardware devices such as read-only memory (ROM), random access memory (RAM), and flash memory, which are specially configured to store and execute program instructions. Examples of the program instructions include not only machine language codes created by a compiler, but also high-level language codes that can be executed by a computer using an interpreter. The above hardware devices may be changed to one or more software modules to perform the processes of the present invention, and vice versa.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

What is claimed is:

1. A method for determining alignment information for golf shot analysis, the method comprising the steps of:
acquiring at least one of first information on a reference position and second information on a target position; and
determining alignment information of a device for golf shot analysis with reference to at least one of the first information and the second information.

2. The method of claim 1, wherein in the acquiring step, at least one of the first information and the second information is acquired from at least one image sensor included in the device.

3. The method of claim 1, wherein in the acquiring step, at least one of the reference position and the target position is estimated on the basis of two or more images respectively acquired from two or more image sensors included in the device, and a result of the estimation is acquired as at least one of the first information and the second information.

4. The method of claim 1, wherein the first information includes at least one of position information of a user and position information of a golf ball.

5. The method of claim 1, wherein in the acquiring step, at least one of the first information and the second information is acquired on the basis of a user's input.

6. The method of claim 1, wherein in the determining step, the alignment information is determined by calculating an angle between a first direction from the reference position to the target position and a second direction from the device to the target position.

7. The method of claim 1, further comprising the step of:
acquiring at least one image of a golf shot, and analyzing the golf shot by applying the alignment information to the at least one image.

8. A non-transitory computer-readable recording medium having stored thereon a computer program for executing the method of claim 1.

9. A system for determining alignment information for golf shot analysis, the system comprising:
an information acquisition unit configured to acquire at least one of first information on a reference position and second information on a target position; and
an alignment information determination unit configured to determine alignment information of a device for golf shot analysis with reference to at least one of the first information and the second information.

10. The system of claim 9, wherein the information acquisition unit is configured to acquire at least one of the first information and the second information from at least one image sensor included in the device.

11. The system of claim 9, wherein the information acquisition unit is configured to estimate at least one of the reference position and the target position on the basis of two or more images respectively acquired from two or more image sensors included in the device, and acquire a result of the estimation as at least one of the first information and the second information.

12. The system of claim 9, wherein the first information includes at least one of position information of a user and position information of a golf ball.

13. The system of claim 9, wherein the information acquisition unit is configured to acquire at least one of the first information and the second information on the basis of a user's input.

14. The system of claim 9, wherein the alignment information determination unit is configured to determine the alignment information by calculating an angle between a first direction from the reference position to the target position and a second direction from the device to the target position.

15. The system of claim 9, further comprising:
a golf shot analysis unit configured to acquire at least one image of a golf shot, and analyze the golf shot by applying the alignment information to the at least one image.
